(19) United States
(12) Patent Application Publication
(10) Pub. No.: US 2006/0099871 A1
(43) Pub. Date: May 11, 2006

(54) Reinforced elastic fiberous web

(75) Inventors: Simon K. Poruthoor, Alpharetta, GA (US); Paul T. Van Gompel, Hortonville, WI (US); Thomas H. Roessler, Appleton, WI (US); Robert C. Pilecky, Oshkosh, WI (US)

Correspondence Address: DORITY & MANNING, P.A., POST OFFICE BOX 1449, GREENVILLE, SC, 29602-1449, US

(73) Assignee: Kimberly-Clark Worldwide, Inc.

(21) Appl. No.: 10/982,453

(22) Filed: Nov. 5, 2004

(51) Int. Cl. D04H 3/00; B32B 9/00

(52) U.S. Cl. 442/394

(57) ABSTRACT

The present invention is directed to a lubricated reinforced fibrous web having a plurality of fibers. A lubricant layer is cross-linked on the fibers to coat the fibers and to form a point-bearing surface on the fibrous web. The cross-linked lubricant layer imparts extensibility and elasticity to the fibrous web for use in a comfort-coated personal care article.

### BACKGROUND OF THE INVENTION

Fibrous web materials such as necked, creped or apertured nonwoven materials or their combinations can be used in a variety of articles and garments such as inner liners in disposable diapers, training pants, and adult undergarments. Such articles should have both extensibility and elasticity; i.e., capacities to stretch and return to their original shape and size once a stretching force is released. Fibrous non-woven materials used to produce these articles may be extensible but are not inherently elastic.

Moreover, due to stiffness of the fibrous non-woven materials that form the articles, skin irritation and discomfort can result when the article is worn against a user's skin. Such stiffness is a result of a combination of factors such as fiber diameter, fiber shape, fiber polymer type, and bond point density.

A need exists in the industry for nonwoven fibrous materials for use in articles and garments that provide comfort and are extensible and elastic.

### BRIEF SUMMARY OF THE INVENTION

The present invention is generally directed to a lubricant-reinforced, elastic, nonwoven fibrous web and a method of making such a web for use in a garment or article such as inner liners in disposable diapers, waistbands, leg bands, feminine care products, adult care products, training pants and the like. The lubricant reinforced fibrous web is elastic, extensible, resistant to tearing and deformation, and comfortable to wear against skin without causing skin irritation.

The elastic nonwoven web can be used, for instance, alone or can be incorporated into a laminate, such as a stretch-bonded laminate or a neck-bonded laminate. When incorporated into such laminates, an elastic layer made in accordance with the present invention is typically attached to at least a non-elastic layer, such as a nonwoven spunbond web. In one embodiment, the elastic layer can be placed between a first outer spunbond layer and a second outer spunbond layer. The elastic layer can be thermally bonded to the spunbond layers or attached according to any other suitable method. The nonelastic layers are generally combined with the elastic layer in a manner that allows the elastic layer to stretch and contract.

According to another aspect of the present invention, lubricant-reinforced, elastic, fibrous webs are produced by cross-linking a lubricant with fibers of inherently nonelastic materials. Various methods for producing such webs include the steps of applying a lubricant solution such as one containing silicone in a pattern on the fibers; transfer coating the silicone solution on the fibers; or dipping the fibers in the silicone solution. The silicone solution can be heated on the fibers to accelerated polymerization of the silicone thereon. Alternatively, the silicone can cross-link with the fibers over time without heating. The cross-linked silicone imparts smoothness and elasticity to the nonwoven fibers as well as making the resultant article resistant to tears and permanent deformation.

Elasticity of the lubricant-reinforced, fibrous web can be controlled by controlling areas of application of the silicone or the silicone solution; by applying more or less of the silicone or the silicone solution; by removing excess silicone or silicone solution after application; or by removing the silicone or the silicone solution from selected areas of the fibrous web or its fibers, including blowing air through holes surrounding the fibers to make those areas permeable to liquids.

Other aspects and advantages of the invention will be apparent from the following description and the attached drawings, or can be learned through practice of the invention.

### BRIEF DESCRIPTION OF THE DRAWINGS

A full and enabling disclosure of the present invention, including the best mode thereof to one of ordinary skill in the art, is set forth more particularly in the remainder of the specification, including reference to the accompanying figures in which:

FIG. 1 is a plan view of one embodiment of a coated web made in accordance with the present invention;

FIG. 2a is a partial cross section view of the web taken along lines 2A-2A in FIG. 1, particularly showing alternative coatings having different thicknesses on the web;

FIG. 2b is a detailed section of the web taken at an area 2B in FIG. 1 showing a relatively thin coating on individual fibers of the web;

FIG. 3 is an exemplary plot of silicone cross-linking showing an exponential temperature-time relationship; and

FIG. 4 is a perspective view showing steps in a method according to another aspect of the invention.

### DETAILED DESCRIPTION

Detailed reference will now be made to the drawings in which examples embodying the present invention are shown. Repeat use of reference characters in the drawings and detailed description is intended to represent like or analogous features or elements of the present invention.

The drawings and detailed description provide a full and detailed written description of the invention and the manner and process of making and using it, so as to enable one skilled in the pertinent art to make and use it. The drawings and detailed description also provide the best mode of carrying out the invention. However, the examples set forth herein are provided by way of explanation of the invention and are not meant as limitations of the invention. The present invention thus includes modifications and variations of the following examples as come within the scope of the appended claims and their equivalents.

### Definitions

As used herein, “extendable” or “extensible” means that property of a material or composite by virtue of which it stretches or extends in the direction of an applied biasing force by at least about 15% of its relaxed length. An extendable material does not necessarily have recovery properties. For example, an elastomeric material is an extendable material having recovery properties. A meltblown web may be extendable, but not have recovery properties and, thus, be an extensible but non-elastic material.

As used herein, “elastomeric,” “elastic,” and “elasticized” refer to a material or composite that can be elongated by an applied force by at least 25% of its relaxed length and which will recover, upon release of the applied force, at least 10% of its elongation. It is generally preferred that the elastomeric material or composite be capable of being elongated by at least 100%, more preferably by at least 300%, of its relaxed length and recover at least 50% of its elongation. An elastomeric material is an extendable material having recovery properties.

As used herein, “non-extensible” refers to a material that does not stretch or extend by at least about 15% of its relaxed length without fracture upon application of a biasing force. Materials that are extensible or elastomeric are not considered “non-extensible.”

As used herein, the term “nonwoven” refers to a web that is not inherently elastic having a structure of individual fibers or filaments that are interlaid, but not in an identifiable repeating manner. Nonwoven webs are formed by a variety of processes such as, for example, spunbonding, melt-blowing, and bonded carded web processes.

As used herein, the term “spunbond fibers” refers to fibers that are formed by extruding a molten thermoplastic material as filaments from a plurality of fine, usually circular capillaries of a spinnerette with the diameter of the extruded filaments then being rapidly reduced.

As used herein, the term “meltblown fibers” refers to fibers formed by extruding a molten thermoplastic material through a plurality of fine, usually circular, die capillaries as molten threads or filaments into a high velocity, usually heated gas (e.g. air) stream that attenuates the filaments of molten thermoplastic material to reduce their diameter, possibly to microfiber diameter. Thereafter, the meltblown fibers are carried by the high velocity gas stream and are deposited on a collecting surface to form a fabric of randomly disbursed meltblown fibers.

As used herein, the term “bonded carded” refers to fibers that are sorted, separated, at least partially aligned, and bonded.

As used herein, the term “microfiber” refers to small diameter fibers having an average diameter not greater than about 100 microns, for example, having an average diameter of from about 0.5 microns to about 50 microns.

As used herein, the terms “cross-linking” and “cross-link” refer to a chemical bond based on a chemical reaction and/or a physical link created as a result of the chemical bond. Thus, cross-linking can indicate both chemical and physical bonding.

More particularly, the cross-link is a transverse connecting element, such as an atom, chemical group, or covalent bond, between parallel chains of a complex organic molecule, especially a polymer or protein. Cross-linking can result from chemical bonding between, for example, silicone and silicone. In the case of silicone on polypropylene, physical bonding occurs between the fibers of the polypropylene and the silicone. Thus, the fibers are held in place by physical bonding between the chemically bonded silicones.

As used herein, the term “polymer” refers to a long, repeating chain of atoms, formed through the linkage of molecules called monomers. The monomers can be identical, or they can be different. Although most are typically organic (based on carbon chains), there are also many inorganic polymers. The term polymer thus covers a large, diverse group of molecules, including substances from proteins to high-strength kevlar fibers. Furthermore, the term “polymer” shall include all possible geometrical configurations of the material, including but not limited to isotactic (e.g., where the monomer is represented “AB”, the isotactic polymer is AB-AB-AB-AB-AB-etcetera), syndiotactic (having regular alternation of opposite configurations at successive regularly spaced positions along the chain), and random symmetries.

As described herein, a binder and a substrate, for example, can be cross-linked in a number of ways. In ultraviolet (UV) cross-linking, unsaturated acrylic esters can be cross-linked with the aid of free radicals generated by a cross-linking additive called a photoinitiator. The photoinitiator creates free radicals through absorption of UV energy, and these radicals react with monomers, multi-functional monomers, as well as oligomers, which will cross-link to form very high-molecular-weight films.

Using irradiation cross-linking, fibrous webs or films can be exposed to electron beam irradiation, which causes the elastomeric polymer contained within the fibers and films to cross-link. Electron beam irradiation bombards the polymer chains, such as polyethylene chains, with high-energy radiation, that can rip hydrogen atoms from the chains creating reactive radical sites, which causes the polymer to cross-link.

In another aspect of the invention, a cross-linking agent can be added to a fibrous web or film. The agent can cause cross-linking of polyethylene, for instance, during melting, extrusion, and spinning processes. For example, heat in an extruder can be used to initiate the cross-linking reaction. Alternatively, the agent may be found in a lubricant mixture that cross-links to fibers of the web.

In a further aspect of the invention, fibrous webs or films coated with the binder and the substrate can be exposed to microwave energy to cross-link the elastomeric polymer contained within the fibers and films and/or the binder and the substrate.

As used herein, an “elastic laminate” is a product comprising two or more layers, such as foams, films and/or nonwoven webs, bonded together to form a laminate wherein at least one of the layers has the characteristics of an elastic polymer. Examples of elastic laminates include, but are not limited to, stretch-bonded laminates and neck-bonded laminates.

As used herein, “stretch-bonded” refers to an elastic member being bonded to another member while the elastic member is extended at least about 25 percent of its relaxed length. “Stretch-bonded laminate” refers to a composite material having at least two layers in which one layer is a gatherable layer and the other layer is an elastic layer. The layers are joined together when the elastic layer is in an extended condition so that upon relaxing the layers, the gatherable layer is gathered. Such a multilayer composite elastic material may be stretched until the nonelastic layer is fully extended.

As used herein, “neck-bonded” refers to an elastic member being bonded to a non-elastic member while the non-elastic member is extended or necked. “Neck-bonded laminate” refers to a composite material having at least two layers in which one layer is a necked, non-elastic layer and the other layer is an elastic layer.

As used herein, “lubricant”, “elastic”, “reinforced elastic”, and “lubricant reinforced elastic” are used interchangeably to mean an elastic material that has reinforcing, elastic, comfort, or lubricant properties and combinations of these properties, such as but not limited to silicone.

### Description of the Drawings

The present invention is directed in general to forming fibrous elastic webs, for instance, from various extruded polymer fibers such as a copolymer of a polyolefin, more particularly, a copolymer of polyethylene or possibly polypropylene. The polyolefin can be copolymerized with various monomers including, for instance, octane, butene, hexane and mixtures thereof. A cross-linking lubricant can be impregnated on and/or between the fibers to impart elasticity, integrity, tear-resistance, and strength to the fibrous elastic web.

In one embodiment, meltblown fibers form a substrate of the fibrous elastic web. The fibers can be continuous or discontinuous. As defined above, these meltblown fabrics are made by extruding a thermoplastic polymeric material through a die to form fibers. As the molten polymer fibers exit the die, a high-pressure fluid, such as heated air or steam, attenuates the molten polymer filaments to form fine fibers. Surrounding cool air is induced into the hot air stream to cool and solidify the fibers. The fibers are then randomly deposited onto a foraminous surface to form a substantially unbonded substrate. The substrate has integrity but can be additionally bonded with a reinforcing elastic or lubricant, discussed below.

In addition to meltblown webs, it should be understood that other fibrous webs can be made in accordance with the present invention. For instance, spunbond webs can be formed by heating a thermoplastic polymeric resin to at least its softening temperature, then extruding it through a spinnerette to form continuous fibers, which can be subsequently fed through a fiber draw unit. The aforementioned lubricant can be added to the polymeric resin while it is soft. From the fiber draw unit the fibers are spread onto a foraminous surface where they are formed into a web.

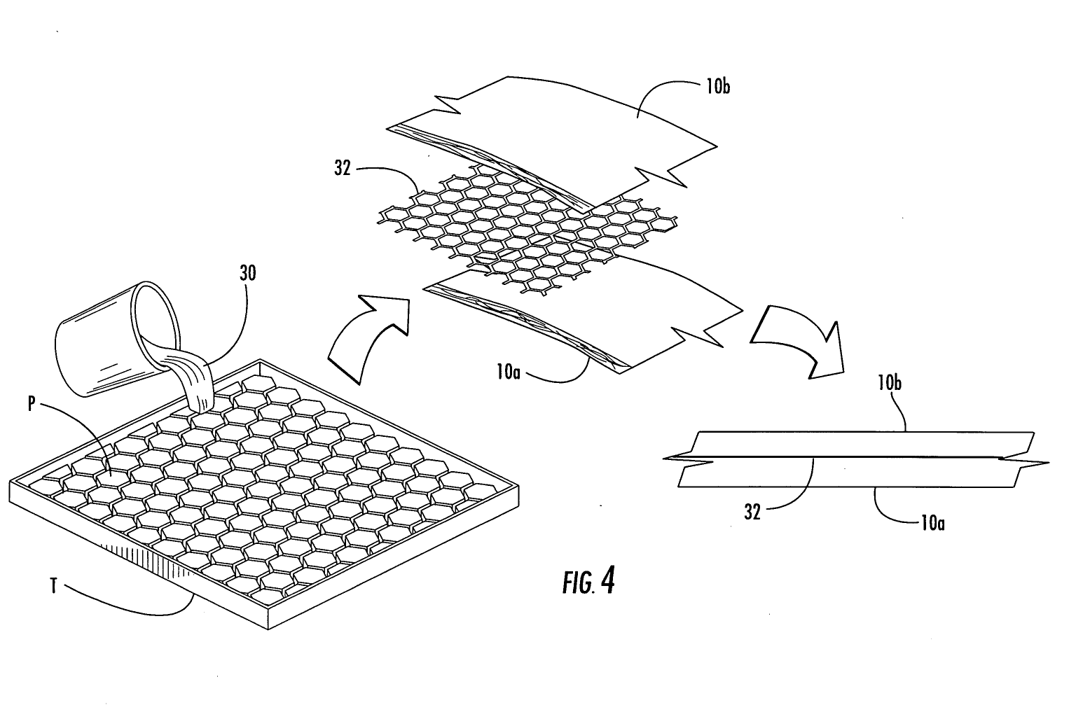

Other substrate options for fibrous elastic webs include bonded carded webs, a wholly unbonded web, a “cross-direction” (CD) extensible neck stretched web, a “machine direction” (MD) extensible creped web, and an inherently CD and/or MD extensible elastic web and various combinations of such webs. For instance, the CD extensible neck stretched web and the MD extensible creped web can each be a substrate layer bonded together in a manner described with respect to FIG. 4 herein.

The manner in which the inherently nonelastic fibrous web is cross-linked with the reinforcing lubricant can vary depending upon the circumstances and the desired results. For instance, in applications requiring a laminate product, the lubricant can be applied and cross-linked after forming the laminate product. In another aspect of the present invention, fibrous webs coated with a lubricant solution can be heated to expedite cross-linking, discussed below.

The lubricants used to reinforce and form the elastic fibrous webs vary according to the present invention. For example, Class VI medical grade silicone as used for implants is suitable for use as the lubricant. One example of such silicone is C6-515 brand silicone available from Dow Corning® Corporation of Midland, Mich. This silicone is supplied as two platinum-catalyzed components (parts A and B) that are mixed into a silicone elastomer. The mixed elastomer cross-links via an addition-cure (platinum-catalyzed) reaction, which can be accelerated by heat. Those skilled in the art will recognize that any skin-friendly lubricant that can be processed and cross-linked with nonwoven fibers can be substituted for silicone; for example, latex and other suitable mixtures, compounds, and materials can be used in lieu of or in addition to silicone.

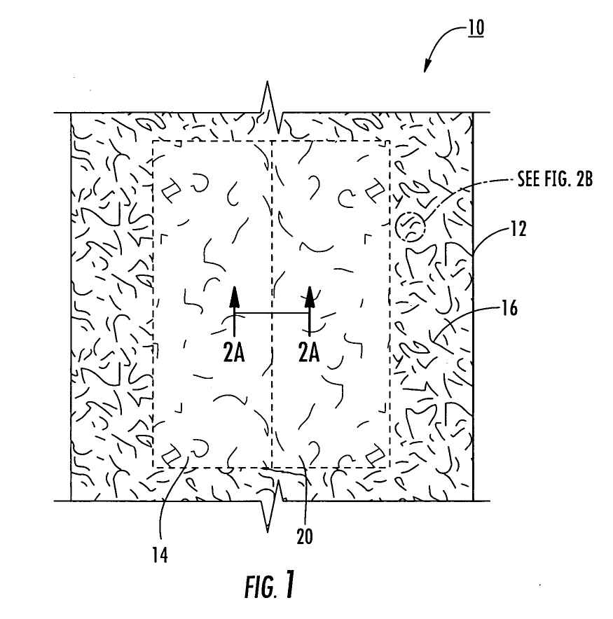

With reference to the figures, an elastic fibrous web made in accordance with an aspect of the invention is shown designated generally by the number 10. As broadly depicted in FIG. 1, the elastic fibrous web 10 includes a fibrous substrate or base 12 made of individual fibers 16 coated with alternative forms of cross-linked films or coatings 14,20. The fibers 16 are made of polypropylene, nylon, or the like such as by melt blowing as described above.

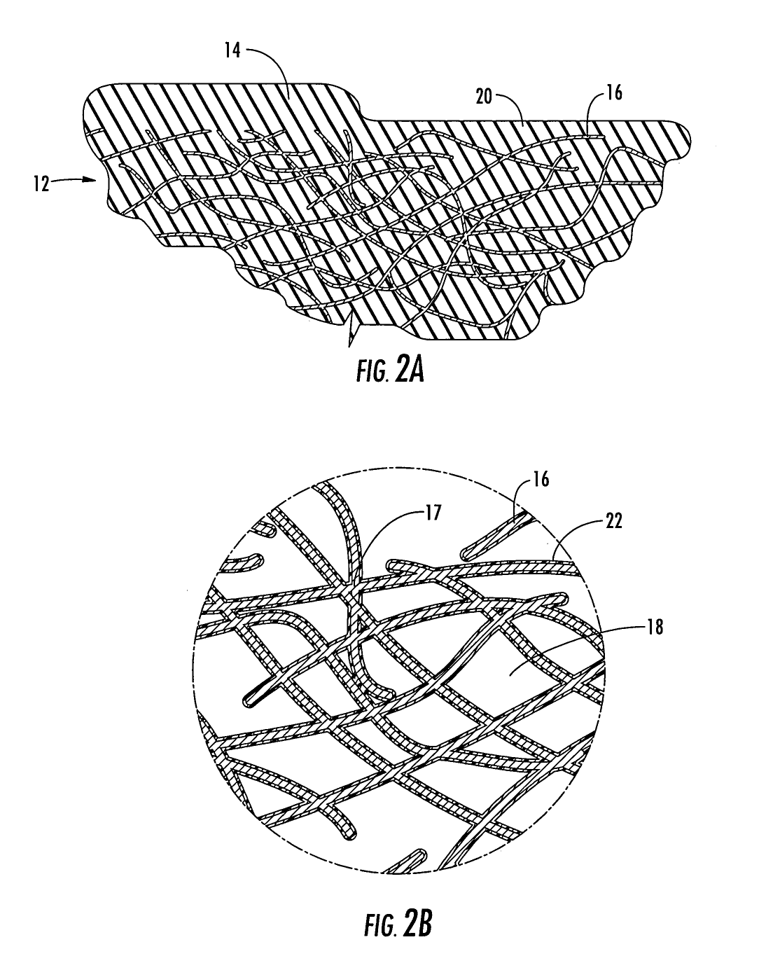

FIG. 2a particularly shows the coatings 14,20 on the fibers 16, which form the fibrous substrate 12. The coatings 14,20 are a fiber-carrying medium formed from a silicone solution that coats and connects the extensible fibers 16. In this example, the silicone solution chemically cross-links to physically connect the fibers 16 to create the elastic fibrous web 10. Production and cross-linking of the silicone is described further below

FIG. 2a comparatively shows that the coating 14 is relatively thicker than the relatively thinner coating 20. Both coatings 14, 20 provide the web 10 with elasticity. For instance, when a stretching force stretches the web 10, the fibers 16 are stretched along with the elastic coatings 14, 20. Upon release of the stretching force, the elastic coatings 14, 20 urge the web 10 and its fibers 16 to return substantially to their original shape and size. By varying the thicknesses of the coatings 14, 20, a degree of elasticity of the web 10 is controlled. In this example, the coating 14 will impart a greater degree of elasticity to the web 10 than the thinner coating 20.

As shown most clearly in FIG. 2B, respective openings or open structures 18 are located around and between the fibers 16. The fibers 16 are extensible due in part to these openings 18 as well to some inherent extensibility of the fibers 16 themselves. More particularly, prior to cross-linking, the fibers 16 exhibit a substantially permanent deformation of at least about 10% when the fibers 16 are subjected to a tensile force of 100 gram-force (gmf) per inch (2.54 cm).

In this aspect of the invention, the openings 18 shown in FIG. 2B are “left open” in contrast to being “filled in” by the coatings 14, 20 as described above to provide another degree of elasticity to the web 10. Specifically, the individual fibers 16 are discretely coated in a manner discussed below with coating 22 such that the surrounding openings 18 are unobstructed by the coating 22. Also in this aspect, the silicone solution is applied at intersection points 17 where the fibers 16 intertwine with one another to create elastic joints between the fibers 16. This arrangement makes the fibrous web 10 permeable to fluids while still imparting elasticity and softness to the fibrous web 10. Those skilled in the art will thus appreciate that by varying the coatings 14, 20, 22, permeability, lubricant, and elastic properties of the web 10 are made to vary.

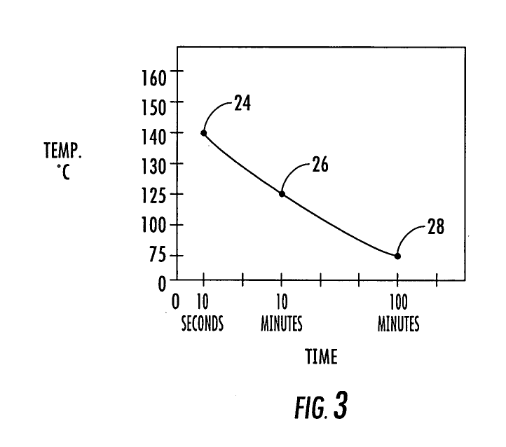

FIG. 3 presents an exponential plot of exemplary cross-linking data. Data point 24 shows, for instance, that silicone was cross-linked on the fibrous web 10 after the silicone solution was heated on the fibers 18 at about 140° C. for about 10 seconds. Data point 26 indicates that the silicone was cross-linked on the fibrous web 10 when the silicone solution was heated on the fibers 18 at about 125° C. for about 10 minutes. Finally, data point 28 shows a similar process at about 75° C for about 100 minutes. Those skilled in the art will appreciate that the curing temperature can be provided by conventional ovens, microwave energy or the like and could be as high as 200° C. provided a substrate fiber can withstand the temperature. It will be further appreciated that temperatures and time shown in FIG. 3 are by way of example only and can differ during production of the web 10. Thus, FIG. 3 is intended to show an exponential relationship of arbitrary temperatures to time using an exemplary substrate and lubricant to show that heating can accelerate cross-linking. In other words, by increasing temperature, the rate in which the lubricant is cross-linked to polymerize on the substrate can be increased. Likewise, a lower or room temperature may require an exponentially longer time to cross-link.

The invention may be better understood with reference to a process or method of providing elasticity, strength, and skin friendly content to a nonwoven fibrous material.

According to one method of the invention, elasticity and comfort properties are imparted to the fibrous web 10 by making a silicone solution using a solvent to thin the silicone. For example, xylene can be used to thin the silicone to coat all or portions of the fibrous web 10 with the coatings 14, 20, 22 having various thicknesses as introduced above. When low concentrations of the silicone solution are used, the resultant silicone coating 22 will be substantially only on the fibers 16 and joints 17 of the fibrous web 10; thus, the web 10 will retain much of its open structure 18, allowing fluids to pass through.

The silicone or silicone solution can be applied to the web 10 in various ways such as in patterns by transfer coating using calendaring processes without covering an entire surface of the web 10. In another aspect, the silicone solution is applied to the web 10 by repetitive dipping in the silicone solution to form the coatings 14, 20, 22. In still another aspect, the web 10 can be saturated with the silicone solution, any solvent therein squeezed out, the web 10 allowed to rebound, and the remaining silicone allowed to cross-link in the web 10. In a further aspect, fibers 16 can be flocked on a surface of a deposited layer of silicone solution, and the silicone allowed to cross-link such that the fibers 16 are locked in place.

As introduced above, an elastic solution can also be applied more particularly at the intersection joints 17 of the fibers 16 to concentrate the coating at the joints 17. By concentrating the elastic coating at the joints 17 instead of entirely coating the fibers 16, the amount of silicone required is reduced. Furthermore, the elastic nature of the web 10 is improved while reducing a slippery surface feel. For example, the web 10, or portions of the web 10, can be saturated with a diluted elastic solution and compressed to squeeze out the excess solution. The web 10 is allowed to expand to draw the solution into capillaries between the fibers 16 where the elastic solution cross-links to form the concentrated elastic joints 17 between the fibers 16.

In another aspect of the invention, some amount of the silicone or silicone solution can be removed after application. For instance, portions of the silicone solution can be removed or thinned by blowing air through the openings 18 before the silicone solution is cross-linked. Conversely, if higher silicone concentrations of the silicone solution are permitted to cross-link before removing some amount of the silicone solution, the film structure or coatings 14, 20 will be formed on the web 10.

With the desired amount of silicone or silicone solution applied to the web 10 in its entirety, in selected areas, or in patterns, the web 10 can be heated to about 120° C. or other appropriate temperature to accelerate cross-linking. At 120° C., for instance, polymerization of the silicone parts will be complete in a few seconds. Also, if xylene is used as the solvent to prepare the silicone solution, the xylene will be expelled by evaporation due to the heating. By cooling the evaporated xylenes, the solvent can be regenerated without gas emissions.

Referring to FIG. 4, a silicone or silicone solution in the form of a liquid 30 is deposited in a non-stick patterned tray T defining, for example, a honeycomb pattern P. The silicone liquid 30 naturally assumes a shape of the pattern P. After a period of cross-linking, a complementary shaped web of honeycomb silicone material 32 can be extracted from the tray T for use as a bonding agent between two or more MD and/or CD extensible webs such as webs 10a, 10b. In this aspect of the invention, the silicone material 32 is extracted and applied to the webs 10a, 10b before the silicone material 32 has completely cured; however, the silicone material 32 is sufficiently cured to have a rubbery structure for handling. Alternatively, the webs 10a,b can be dipped one or more times in the silicone liquid 30 to pick-up and form the patterned silicone material 32 on the webs 10a,b. Still further, the honeycomb web 32 could be formed in a continuous manner, for example, by coating an engraved roll (not shown). The continuous, honeycomb web 32 can be printed onto a bonded or unbonded fibrous web 10a, 10b and the elastic allowed to cross-link.

After extraction, printing, dipping or the like, the semi-cured silicone material 32 will finish cross-linking and interlink individual fibers of the webs 10a,b together as described above in order to provide inner and outer cloth-like surfaces with an elastic core. Moreover, the resultant honeycomb structure of the silicone material 32 provides extensibility in numerous directions, strength, and integrity of the laminated webs 10a,10b. Those skilled in the art will recognize that any pattern can be substituted for or used in combination with the honeycomb pattern P to reinforce the webs 10a,10b in CD, MD or various other directions.

Those skilled in the art will further appreciate that the pattern P can be defined in a bonder roller arrangement in lieu of the tray T. For instance, the bonder roller arrangement may include a patterned calender roller, such as a pin embossing roller (not shown), arranged with a smooth anvil roller (not shown). One or both of the calender roller and the smooth anvil roller may be heated and the pressure between these two rollers may be adjusted in a known manner to provide the desired temperature and bonding pressure to apply the silicone liquid 30 to the webs 10a,b.

Specific tests of the inventive concepts described above include:

### EXAMPLE I

1. Dilute silicone with xylene solvent to make a silicone solution.

2. Soak a spun bond neck stretch web material in the silicone solution.

3. Remove excess solution from the spun bond neck stretch material.

4. Heat the spun bond material in an oven at about 118° C. for about 15 minutes to polymerize the silicone with fibers of the spun bond neck stretch material.

### EXAMPLE II

1. Place thin lines of silicone on an aluminum plate, or other non-stick surface.

2. Transfer the lines of silicone onto a spun bond neck stretch fibrous web by pressing the fibrous web onto the silicone material.

3. Place the fibrous web in an oven at about 118° C. for about 15 minutes to polymerize the silicone with fibers of the spun bond neck stretch material.

The lowest concentration of silicone solution tested contained 12.5% (by weight) of silicone in xylene; e.g., 12.5 grams of silicone to 87.5 grams of xylene. Much lower concentrations can be used if multiple step coating is employed. Specifically, the web 10 can be coated with the silicone solution, the xylene evaporated by heat or airflow, and the web 10 coated again with the silicone solution. The steps can be repeated until the desired elasticity and thickness of the coatings 14,20 are achieved.

The foregoing test methods provided the web 10 with increased elasticity and tear resistance that exhibited smoothness and non-skin irritating properties. For example, the fibrous webs 10 produced in Examples I and II each had fibers 16 with irregular or non-uniform surfaces that normally have microscopic peaks and valleys that may irritate the skin. With the lubricant layer of silicone impregnated in the web 10 and cross-linked on the fibers 16, the irregular surfaces of the web 10 were coated to form one smooth, point-bearing surface on the fibrous web 10. Thus reinforced with cross-linked silicone, the fibrous web 10 exhibited extensibility and elasticity with excellent fit and containment properties for use in a personal care article. Moreover, the point-bearing surface is disposed against a user's skin to provide smoothness such that the personal care article is non-irritating to the skin and comfortable to wear.

While various embodiments of the invention have been shown and described, those skilled in the art will recognize that other changes and modifications may be made to the foregoing embodiments without departing from the spirit and scope of the invention. For example, various lubricants can be used on various nonwoven materials and cross-linked according to various methods to suit particular applications and to make particular articles. It is intended to claim all such changes and modifications as fall within the scope of the appended claims and their equivalents.

That which is claimed is:

1. A method for producing a silicone reinforced elastic laminate, the method comprising the steps of:
providing a fibrous web of nonwoven material;
applying a silicone to a plurality of fibers of the nonwoven material; and
cross-linking the silicone to polymerize the silicone on the fibers of the nonwoven material.

2. The method of claim 1, wherein the fibrous web of nonwoven material is a meltblown web or a spunbond web.

3. The method of claim 1, wherein the fibrous web of nonwoven material is selected from the group consisting of an unbonded web, a bonded carded web, a CD extensible neck stretched web, an MD extensible creped web, an extensible web, an elastic web, and combinations thereof.

4. The method of claim 1, wherein the silicone is a silicone solution including a silicone reagent and a solvent.

5. The method of claim 4, wherein the applying step is conducted by dipping the nonwoven material in the silicone solution.

6. The method of claim 4, wherein the applying step is conducted by transfer coating the nonwoven material in the silicone solution.

7. The method of claim 1, wherein the applying step is conducted by applying the silicone in a pattern on the nonwoven material.

8. The method of claim 1, further comprising the step of heating the silicone on the fibers to polymerize the silicone at an increased rate.

9. The method of claim 1, further comprising the step of heating the silicone on the fibers between 110° C. to 125° C. to polymerize the silicone at an increased rate.

10. The method of claim 1, wherein the cross-linking step is conducted by heating the silicone on the fibers for 15 seconds to 15 minutes to polymerize the silicone thereon.

11. The method of claim 1, further comprising the step of controlling an elasticity of the fibers by controlling a concentration of the silicone.

12. The method of claim 11, wherein the concentration of the silicone is controlled by mixing a silicone solution.

13. The method of claim 12, further comprising the step of forming a film structure on the fibers by coating the fibers with the silicone solution such that the nonwoven material retains a plurality of liquid permeable openings therethrough.

14. The method of claim 13, further comprising the step of blowing air through the coated fibrous web before the cross-linking step.

15. The method of claim 12, further comprising the step of forming a film structure on the fibers from the silicone solution to render the nonwoven material impermeable to liquid.

16. The method of claim 12, further comprising the step of applying the silicone solution at intersection points of the fibers to create elastic joints between the fibers.

17. The method of claim 1, further comprising the step of controlling a thickness of the polymerized silicone on the fibers by increasing or decreasing an amount of the silicone applied to the nonwoven material.

18. A method for producing a reinforced elastic fibrous web, the method comprising the steps of:
depositing a layer of elastic on a non-stick surface, the layer presenting an exposed surface;
applying a plurality of fibers of nonwoven material to the exposed surface; and
cross-linking the elastic to interlink the fibers.

19. The method as in claim 18, wherein the elastic is a silicone solution.

20. The method as in claim 19, wherein the silicone solution is mixed before depositing as the layer on the non-stick surface.

21. The method as in claim 18, wherein the non-stick surface is disposed on a patterned tray and further comprising the step of depositing the silicone solution therein.

22. The method as in claim 21, further comprising the step of extracting cross-linked silicone from the patterned tray, the cross-linked silicone exhibiting a complementary pattern in the form of the patterned tray.

23. The method as in claim 22, wherein the complementary pattern is a honeycomb pattern.

24. The method as in claim 18, wherein the elastic is a silicone material, a silicone solution, a latex material, or combinations thereof.

25. The method as in claim 18, wherein the step of applying fibers to the exposed surface is conducted by flocking the fibers onto the exposed surface to impregnate at least a portion of the fibers with the elastic.

26. The method as in claim 18, wherein the fibers of the nonwoven material define a first extensible web and further comprising the step of forming an elastic laminate using the elastic as a bonding agent between the first extensible web and a second extensible web, the elastic configured as an elastic core.

27. The method as in claim 26, wherein the two webs each define a cloth-like surface.

28. The method as in claim 18, wherein the plurality of fibers of nonwoven material define an unbonded fibrous web and further comprising the step of saturating the web with the elastic.

29. The method as in claim 28, wherein the elastic is a silicone solution including a solvent, and further comprising the steps of removing the solvent from the silicone solution by compressing the fibrous web prior to the cross-linking step.

30. A silicone reinforced elastic fibrous web, comprising: a fibrous web of nonwoven material having a plurality of fibers, each of the fibers including a plurality of non-uniform surfaces thereon; and
a silicone layer cross-linked on the fibrous web, the silicone layer configured to coat the non-uniform surfaces of the fibers to form a point-bearing surface on the fibrous web, the silicone layer further configured to impart elasticity and extensibility to the fibrous web for use in personal care articles.

31. The fibrous web of claim 30, wherein the plurality of fibers have a plurality of openings therebetween and wherein the silicone layer coats the fibers and openings such that the fibrous web is impermeable to a liquid.

32. The fibrous web of claim 30, wherein the plurality of fibers have respective openings therebetween and wherein the silicone layer coats the fibers without obstructing their respective openings such that the fibrous web is liquid permeable.

33. A reinforced fibrous web, comprising:
a plurality of fibers forming a fibrous web defining a plurality of surfaces thereon; and
an elastic layer cross-linked on the fibers to coat the surfaces and form a point bearing surface on the fibrous web, the cross-linked elastic layer configured to impart extensibility and elasticity to the fibrous web for use in a personal care article, the point bearing surface disposed between the fibers and skin such that the point bearing surface is against the skin.

34. The fibrous web of claim 33, wherein the elastic layer is silicone or latex.

35. The fibrous web of claim 33, wherein the plurality of fibers defines a plurality of openings therebetween and wherein the elastic layer coats the fibers and openings such that the fibrous web is impermeable to a liquid.

36. The fibrous web of claim 33, wherein the plurality of fibers defines a plurality of openings therebetween and wherein the elastic layer coats the fibers such that the fibrous web is liquid permeable.

37. A lubricant reinforced fibrous web, comprising:
a plurality of fibers forming an extensible fibrous web; and
a lubricant layer cross-linked with the fibers to form a fiber-carrying medium configured to impart elasticity to the extensible fibrous web.

38. The lubricant reinforced fibrous web as in claim 37, wherein the fibers are non-woven fibers.

39. The lubricant reinforced fibrous web as in claim 37, wherein the lubricant layer is silicone or latex.

40. The lubricant reinforced fibrous web as in claim 37, wherein the lubricant layer is configured to chemically react to polymerize.

41. The lubricant reinforced fibrous web as in claim 40, wherein the polymerized lubricant layer is connected to the fibers.

42. The lubricant reinforced fibrous web as in claim 37, wherein the fibers define a plurality of openings therebetween and wherein the lubricant layer coats the fibers and the openings such that the fibrous web is impermeable to a liquid.

43. The lubricant reinforced fibrous web as in claim 37, wherein the plurality of fibers defines a plurality of openings therebetween and wherein the lubricant layer coats the fibers such that the fibrous web is liquid permeable.

44. The lubricant reinforced fibrous web as in claim 37, wherein the plurality of fibers are intertwined to form joints and wherein the lubricant layer coats the joints to impart elasticity to the fibrous web.
